(19) United States
(12) Patent Application Publication
(10) Pub. No.: US 2010/0259746 A1
(43) Pub. Date: Oct. 14, 2010

(54) PROFILOMETER

(75) Inventors: Yasuhiro Ohnishi, Kyotanabe-shi (JP); Masatoshi Kimachi, Osaka (JP); Masaki Suwa, Soraku-gun (JP); Shree Nayar, New York, NY (US)

Correspondence Address: OSHA LIANG L.L.P., TWO HOUSTON CENTER, 909 FANNIN, SUITE 3500, HOUSTON, TX, 77010, US

(73) Assignee: OMRON Corporation, Kyoto-Shi (JP)

(21) Appl. No.: 12/421,994

(22) Filed: Apr. 10, 2009

(51) Int. Cl. G01C 3/08

(52) U.S. Cl. 356/4.01

(57) ABSTRACT

A profilometer for measuring a surface profile of a measuring target has a lighting device for irradiating the measuring target with light, an imaging device for imaging a reflected light from the measuring target, and a normal calculation section for calculating a normal direction of a surface at each position of the measuring target from an imaged image. The lighting device has a light emission region of a predetermined extent. A radiance of center of gravity of a light source distribution of a point symmetric region coincides with a radiance of the center of the point symmetric region in an arbitrary point symmetric region of the light emission region.

### BACKGROUND OF THE INVENTION

1. Technical Field

The present invention relates to a technique of measuring the profile of a surface or surface normals of a measuring object.

2. Related Art

A technique of using color information and a technique of using luminance information are conventionally known as a technique of measuring a normal profile of a measuring target.

A color highlight method is known as a technique of measuring the normal profile using the color information. As shown in FIGS. 20A and 20B, the color highlight method includes arranging red, blue, and green ring lightings in a dome, and irradiating the measuring target with each color. The direction of a normal line (only zenith angle component) of the surface to be measured is distinguished in three ways by analyzing the color of reflected light from the measuring target to calculate the surface profile. As a modification of the color highlight method, a technique (refer to, for example, Japanese Patent Application Laid-Open No. 3-142303) of finely measuring the normal line (only zenith angle component) of the surface to be measured by arranging great number of concentric lightings in a hood, and a technique (refer to, for example, Japanese Patent Publication No. 3553652) of performing photography using two types of lighting patterns of a zenith angle component measurement pattern and an azimuth angle component measurement pattern, and calculating the zenith angle component and the azimuth angle component of the normal line from the respective images are known.

An illuminance difference stereo method is known as a technique of measuring the normal profile to be measured using the luminance information. As shown in FIG. 21, the illuminance difference stereo method is a method of acquiring the normal direction at each point of the object surface based on a plurality of images photographed one at a time under three or more different light sources using shadow information of the object. More specifically, the luminance information is acquired using an object which profile is known, for example, from three images photographed under different light sources. The direction of the normal line is uniquely determined by a set of luminance values, and is saved as a table. In time of measurement, photography is performed under three light sources, and the normal line is obtained from a set of luminance information with reference to the created table. According to the illuminance difference stereo method, the normal line of an object, which does not have a perfect mirror surface, can be obtained.

### SUMMARY

In the color highlight method using color features, an object whose reflectance property is not uniform cannot be measured. Furthermore, the measurement accuracy decreases due to color mixture of the reflected light when an imperfect mirror surface (that includes a specular lobe) is used even if the reflectance property is uniform. The term specular lobe here indicates spread of specular reflection caused by concave-convex microsurface, called microfacet, on the measurement surface. The larger the direction variance of the microfacet is (the rougher the surface is), the wider the specular lobe is. Conversely, small direction variance of microfacet means that the surface is mirror-like one.

In the illuminance difference stereo method using the luminance information, the object whose reflectance property is uniform can be measured other than the perfect mirror surface, but the accuracy in normal calculation decreases if the reflectance property is not uniform since the luminance value varies depending on the reflectance property. The accuracy in the normal calculation decreases even if the object has uniform reflectance property when the reflectance properties of the object (reference object) used in creating a table and the measuring object are different.

One or more embodiments of the present invention provides a technique capable of calculating, with satisfactory accuracy, the normal information (XYZ component of unit vector, or zenith angle component and azimuth angle component) even for a measurement target in which the reflectance property is not uniform, or in which the reflectance property is uniform but the reflectance property itself differs from the reference object.

In one or more embodiments of the present invention, a lighting device having a distribution in which a radiance of a reflected light when a measuring target having arbitrary reflectance property is irradiated with light becomes the same as a radiance in the perfect mirror surface. In other words, a lighting device that can handle the target which contains specular lobe similar to the perfect mirror surface when a measuring target is photographed under such lighting is used.

A profilometer for measuring a surface profile of a measuring target according to one or more embodiments of the present invention includes a lighting device for irradiating the measuring target with light, an imaging device for imaging a reflected light from the measuring target, and a normal calculation means for calculating a normal direction of a surface at each position of the measuring target from an imaged image, where the lighting device has the following features.

In order for the lighting device to have the above features, the lighting device merely needs to have a light source distribution in which a radiance of center of gravity of the light source distribution of a point symmetric region coincides with a radiance of the center of the point symmetric region for an arbitrary point symmetric region of the light emission region.

Assuming the light source distribution in the light emission region of the lighting device is Lᵢ(p, θ, φ), the radiance (camera luminance value) Lᵣ(p, θᵣ, φᵣ) at position p on surface can be generally expressed as below with the reflectance property of the object surface as f(p, θᵢ, φᵢ, θᵣ, φᵣ).

Lᵣ(p,θᵣ,φᵣ)=∫∫_{Ω}Lᵢ(p,θᵢ,φᵢ)·f(p,θᵢ,φᵢθᵣ,φᵣ)cos θᵢ sin θᵢdθᵢdφᵢ (1)

Here, Ω is a solid angle of a hemispherical surface.

In particular, if the object surface is a perfect mirror surface, the radiance Lᵣ can be expressed as below.

Lᵣ(p,θᵣ,φᵣ)=Lᵢ(p,θᵢₛ,φᵢₛ+π) (2)

Here, in an arbitrary region (range of light source distribution) Ω(θᵢₛ, φᵢₛ) internally including (θᵢₛ, φᵢₛ), the object can be handled as a perfect mirror surface, even with respect to an object whose target surface is an imperfect mirror surface, by using a light source distribution Lᵢ(p, θ, φ) that satisfies the right side of the equation (1)=the right side of the equation (2).

However, it is analytically difficult to obtain the light source distribution Li(p, θ, φ) that precisely satisfies the right side of the equation (1)=the right side of the equation (2). Thus, consider the light source distribution Li(p,θ,φ) in which the right side of the equation (2)—the right side of the equation (1) becomes a sufficiently small value.

A specific example of an approximation solution satisfying the above condition includes a light source distribution in which the light source distribution linearly changes with respect to the longitude, assuming a sphere in which the measuring target is at the center and both poles are on a plane including the measuring target. Another example is a light source distribution in which the light source distribution linearly changes with respect to the latitude. Another further example is a light source distribution in which the light emission region has a planar shape, and which linearly changes on the plane thereof.

Such light source distributions are the approximate solutions for (1)=(2), where even the object whose target surface is an imperfect mirror surface can be handled as if the target is a perfect mirror surface by using such lighting device.

It is preferable to use the light source distribution that satisfies the above condition, and in which a plurality of light source distributions different from each other is overlapped. A normal vector of a target in plurals and with different reflectance property thus can be uniquely calculated with the same degree of freedom as the number of overlapped light sources

According to one or more embodiments of the present invention, a surface profile measurement method includes some of the above-described processes, and one or more embodiments of the present invention includes a program for realizing such a method. The above-described means and processes can be respectively combined to each other as much as possible to configure one or more embodiments of the present invention.

According to one or more embodiments of the present invention, the normal information (XYZ component of unit vector, or zenith angle component and azimuth angle component) can be calculated with satisfactory accuracy even on a measuring target in which the reflectance property is not uniform, or in which the reflectance property is uniform but which reflectance property itself differs from the reference object.

### BRIEF DESCRIPTION OF THE DRAWINGS

FIG. 1 shows a view showing a brief overview of a three-dimensional measurement device in a first embodiment;

FIG. 2 shows a view showing function blocks of the three-dimensional measurement device in the first embodiment;

FIG. 3 shows a view showing another example of a profilometer;

FIG. 4 shows a view showing a color pattern in a light emission region of the lighting device for every RGB;

FIGS. 5A and 5B show views describing change in each color of RGB in the light emission region of the lighting device, where FIG. 5A is a perspective view and FIG. 5B is a side view;

FIG. 6 shows a view describing reflectance property;

FIGS. 7A and 7B show photographed images in a case where a mirror surface object of FIG. 7A and an object of FIG. 7B in which reflectance property is not uniform are irradiated with lighting of a stripe-form color pattern, where the color pattern is broken in FIG. 7B;

FIG. 8 shows a view for describing calculation of radiance;

FIG. 9 shows a view describing effects by a color pattern of the lighting device in the first embodiment;

FIGS. 10A and 10B show photographed images in a case where a mirror surface object of FIG. 10A and an object of FIG. 10B in which reflectance property is not uniform are irradiated with lighting of the present embodiment, where the color pattern is maintained in FIG. 10B;

FIG. 11 shows a view describing a correspondence of a direction of a normal line of a surface to be measured and a light emission region;

FIG. 12 shows a view showing function blocks of a surface profile calculation unit;

FIG. 13 shows a view describing effects by a color pattern of the lighting device in the first embodiment;

FIGS. 14A and 14B show views showing another example of a color pattern of the lighting device;

FIGS. 15A and 15B show views showing a color pattern of a lighting device in a second embodiment;

FIG. 16 shows a view showing a brief overview of a three-dimensional measurement device according to the second embodiment;

FIG. 17 shows a view showing a color pattern in the second embodiment for every RGB;

FIG. 18 shows a view showing the principle of a three-dimensional measurement;

FIG. 19 shows a view describing a case of performing the three-dimensional measurement on a mirror surface object;

FIGS. 20A and 20B show views describing a surface profile measurement by a color highlight method, where FIG. 20A shows a view of a brief overview of the device and FIG. 20B shows a view showing a measurement principle; and

FIG. 21 shows a view describing a surface profile measurement by an illuminance difference highlight method.

### DETAILED DESCRIPTION

Preferred embodiments of the invention will now be illustratively described in detail with reference to the drawings.

### First Embodiment

### <Brief Overview>

A profilometer (normal measurement device) according to a first embodiment is used as one part of a three-dimensional measurement device for performing a three-dimensional measurement of a mirror surface object. As shown in FIG. 18, the three-dimensional measurement (triangulation) is a technique of examining the correspondence relationship of pixels from images photographed with a plurality of cameras of different imaging angle, and calculating a parallax to measure the distance. Normally, the corresponding pixel is examined by calculating the similarity with the luminance value as a feature quantity when examining the corresponding pixel.

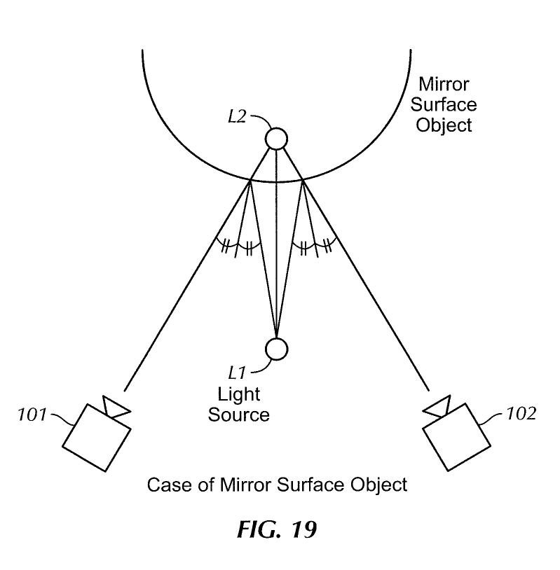

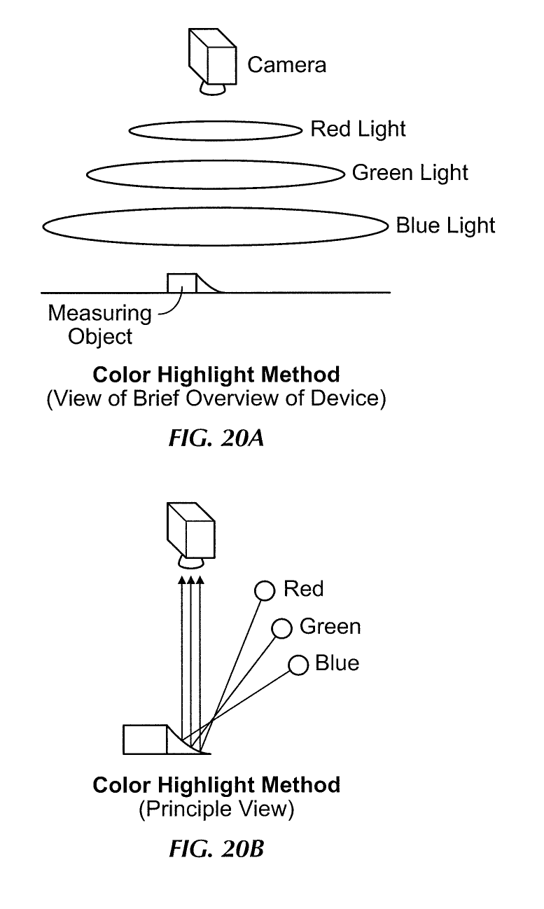

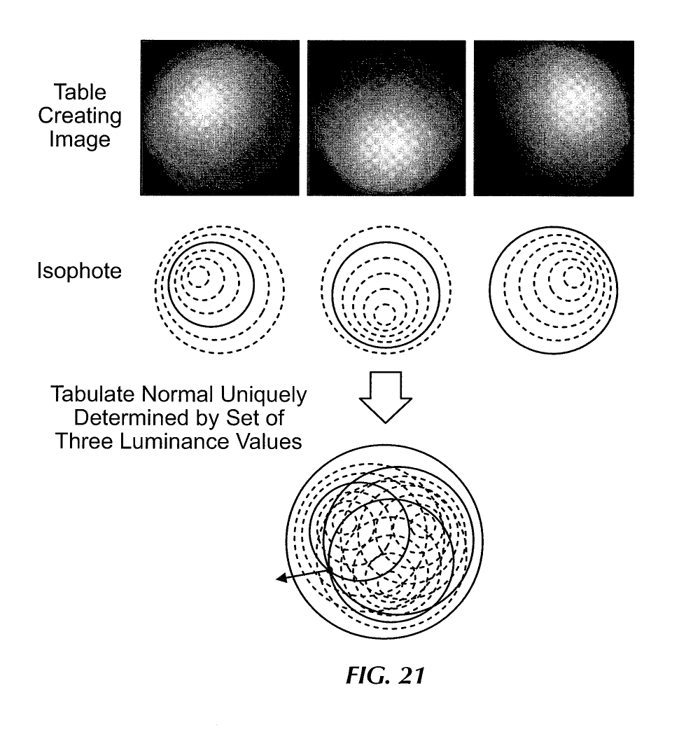

If the measuring target is a mirror surface object, the luminance value photographed in the image does not represent the feature quantity of the object surface itself, but is determined by the reflection of the surrounding object. Therefore, when the mirror surface object is photographed with two cameras, as shown in FIG. 19, the position of the object surface where the emitted light from a light source L1 reflects differs. In performing the three-dimensional measurement using such points as the corresponding pixel, the location of point L2 in the figure is actually measured, and the error occurs. The larger the difference in the imaging angles of the cameras, the larger the error.

The cause of such error is that the luminance information reflecting on the surface of the mirror surface object is not the feature of the surface itself of the mirror surface object. That is, in order to correctly perform the three-dimensional measurement, the correspondence of the pixel between the imaged images needs to be examined focusing on the feature of the surface of the mirror surface object. The direction of the normal vector can be used for the feature of the surface of the mirror surface object. Thus, in the three-dimensional measurement device according to the present embodiment, the three-dimensional measurement is performed focusing on the direction of the normal line of the object surface.

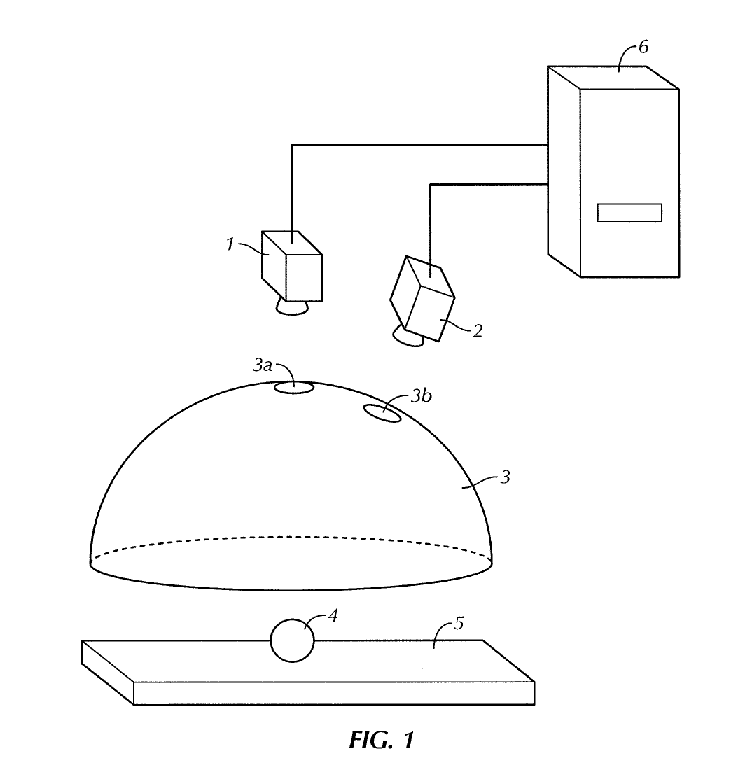

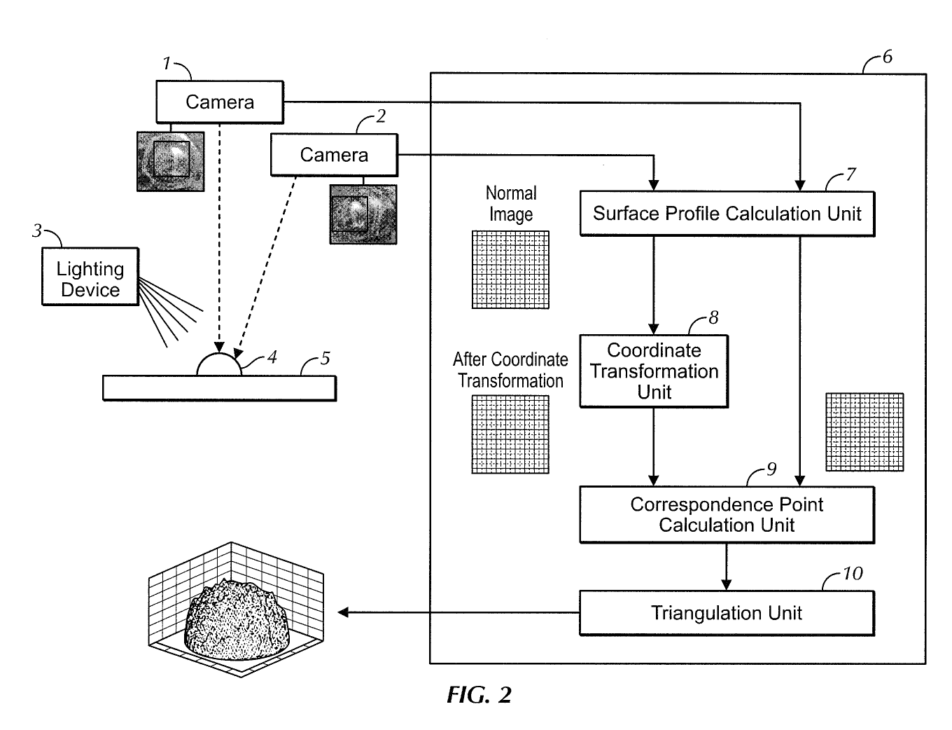

FIG. 1 shows a view showing a brief overview of the three-dimensional measurement device according to the present embodiment. FIG. 2 shows a view showing function blocks of the three-dimensional measurement device according to the present embodiment. As shown in FIG. 1, a measuring target 4 arranged on a stage 5 is photographed by two cameras 1, 2. Here, the camera 1 takes pictures from a vertical direction, and the camera 2 takes pictures from a direction shifted by about 40 degrees from the vertical direction. The measuring target 4 is irradiated with light from a dome-shaped lighting device 3, and the cameras 1, 2 photograph the reflected light of the light from the lighting device 3. The photographed image is retrieved into a computer 6, then image processed, and three-dimensional measurement is performed.

The computer 6 functions as a surface profile calculation unit 7, a coordinate transformation unit 8, a correspondence point calculation unit 9, and a triangulation unit 10, as shown in FIG. 2, by causing a CPU to execute a program. Each function unit may be partially or entirely realized by a dedicated hardware.

The images photographed by the cameras 1, 2 are respectively input to the surface profile calculation unit 7. The surface profile calculation unit 7 calculates the direction of the normal line at each position of the photographed measuring target 4. The details of the calculation process of the normal direction will be hereinafter described in detail.

The coordinate transformation unit 8 performs a coordinate transformation process of aligning the direction of the normal line calculated from the image photographed by the camera 2 to the coordinate system of the camera 1. The positional relationship of the cameras 1, 2 is adjusted in calibration performed prior to the measurement. A transformation matrix for transforming from the coordinate system of the camera 2 to the coordinate system of the camera 1 is obtained from the parameters acquired in the calibration.

The correspondence point calculation unit 9 calculates the corresponding pixel from two normal images, which coordinate systems are unified. This process is performed by obtaining the normal line of the same direction as the normal line at the focusing pixel in the normal image of the camera 1 from the normal image of the camera 2. In this case, the corresponding pixel exists on an epipolar line, and thus the relevant line merely needs to be searched. When searching for the pixel having the normal line of the same direction, the pixel having the highest similarity is searched using not only the information on only one focusing pixel but also information on the surrounding pixels thereof. The similarity can be obtained using a 7 pixel by 7 pixel window having the focusing pixel as a center with the position at where the direction of the normal lines matches the most as the correspondence pixel.

After the correspondence point in two images is obtained in the above manner, the depth information (distance) is calculated for each position of the measuring target 4 by the triangulation unit 10. This process is a known technique, and thus detailed description will be omitted.

<Surface Profile Measurement>

A process of calculating the surface profile (normal) of the measuring target 4 will now be described in detail.

[Lighting Device]

First, a configuration of a device for measuring the surface profile will be described. As shown in FIG. 1, for surface profile measurement, the measuring target 4 is lighted with a light radiated from the dome-shaped lighting device 3, and the reflected light thereof is photographed with the cameras 1, 2. The photographed image is image processed by the computer 6 to measure the surface profile. The lighting device 3 is formed with two holes 3a, 3b to photograph the cameras 1, 2.

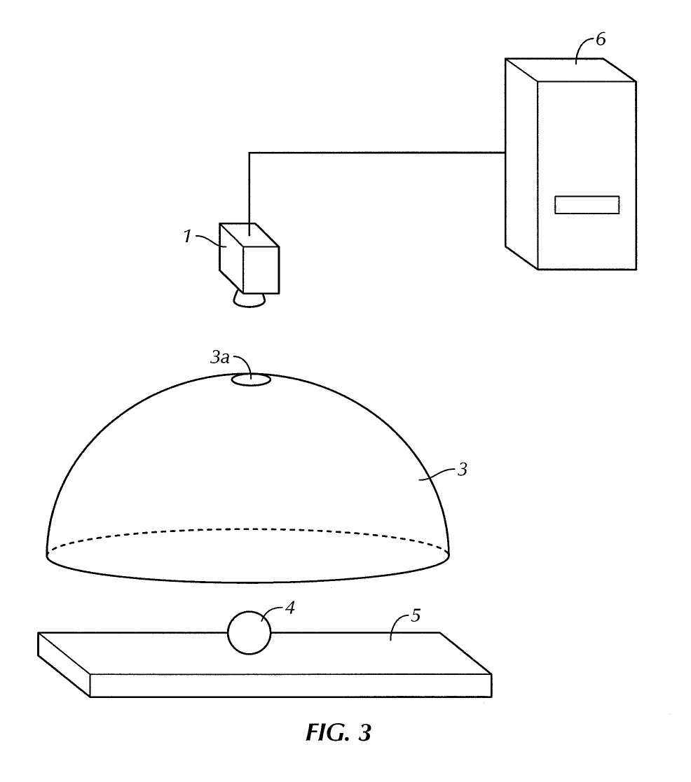

In the present embodiment, a configuration of using two cameras is adopted since the surface profile is measured for three-dimensional measurement, but only one camera may be arranged as shown in FIG. 3 if the purpose is to simply measure the surface profile without performing the three-dimensional measurement. In this case, the measurement of the surface profile can be performed by performing an integral process on the normal image of the camera 1 or the camera 2.

The lighting device 3 has a dome-shape as shown in the figure, and the entire dome shape is the light emission region. Such lighting device 3 can be configured by, for example, a dome-shaped color filter and a light source for radiating white light from the exterior thereof. Furthermore, a configuration in which a plurality of LED chips is arrayed on the inner side of the dome to radiate light through a diffusion plate may be adopted. A liquid crystal display, an organic EL display, and the like may be formed to a dome shape to configure the lighting device 3.

The profile of the light emission region of the lighting device 3 is preferably a hemispherical dome-shape such that light can be radiated from all directions of the measuring target. The normal line in every direction thus can be measured. However, as long as the shape is such that light is radiated from a position corresponding to the normal direction to be measured, the shape of the light emission region may be of any shape. For instance, if the direction of the normal line of the surface is limited to substantially the vertical direction, the light does not need to be radiated in the horizontal direction (from direction of shallow angle)

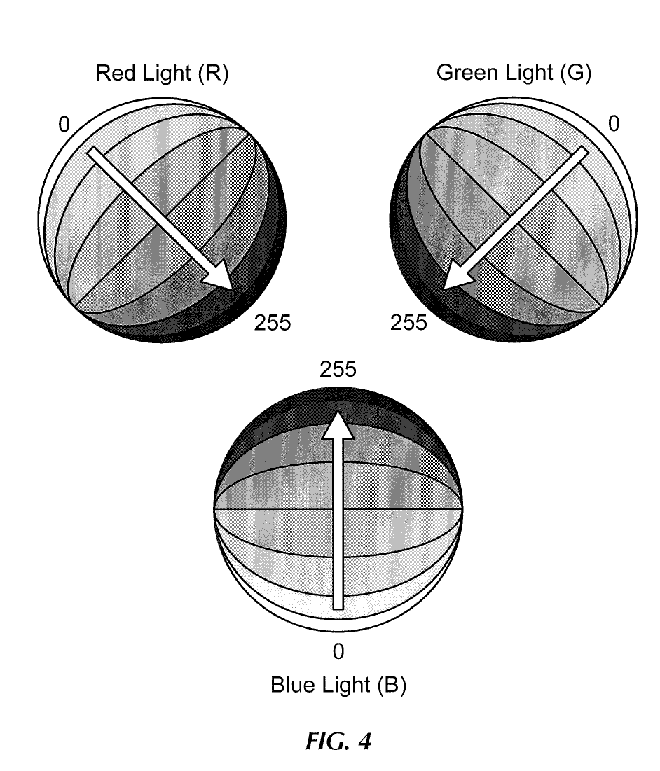

The light emission at each position of the light emission region of the lighting device 3 is set to emit light of spectral distribution different at all positions. For instance, when light emission is realized by synthesizing light components of three colors of red light (R), green light (G), and blue light (B), the light emission intensity of each component of RGB is changed with respect to different directions on the dome as shown in FIG. 4. Here, the changing direction is set to 120 degrees with respect to each other. Through the combination of such RGB components, the light emissions at each position of the light emission region all have different combination of each component of RGB. Therefore, if the light of spectral distributions different at all positions is emitted, and the incident direction to the measuring target is different, the spectral distribution (intensity ratio of RGB) of the incident light can be set to be different. The number of color channels are not limited to three in the present invention. The use of more than 3 color channels (multispectral) provides more detailed information for accurate measurement of surface.

FIGS. 5A and 5B show change in intensity of one component light in FIG. 4. FIG. 5A is a perspective view showing an isochromatic line (equal light emission intensity) of one component light. FIG. 5B is a side view corresponding to FIG. 5A. A line of intersection of a plane passing through the diameter of the dome (hemisphere) and the dome becomes the isochromatic line. In FIGS. 4 and 5, the light emission intensity of each component of RGB is shown to change in a step-wise manner (in the figure, change in eight steps), but this is to facilitate the view of the drawing, and actually, the light emission intensity of each component light continuously changes. The change in light emission intensity is set to linearly change with respect to an angle. More specifically, assuming the minimum value of the light emission intensity is Lₘᵢₙ, the maximum value of the light emission intensity is Lₘₐₓ, and the angle formed by the plane including the isochromatic line and the horizontal plane is θ, the light emission intensity is set so that the light emission intensity L(θ) on the isochromatic line satisfies the relationship L(θ)=Lₘᵢₙ+(Lₘₐₓ−Lₘᵢₙ)×(θ/π). Defining “pole” as shown in FIG. 5A, E is the longitude, and the light source distribution in the present embodiment can be expressed as linearly changing with respect to the longitude.

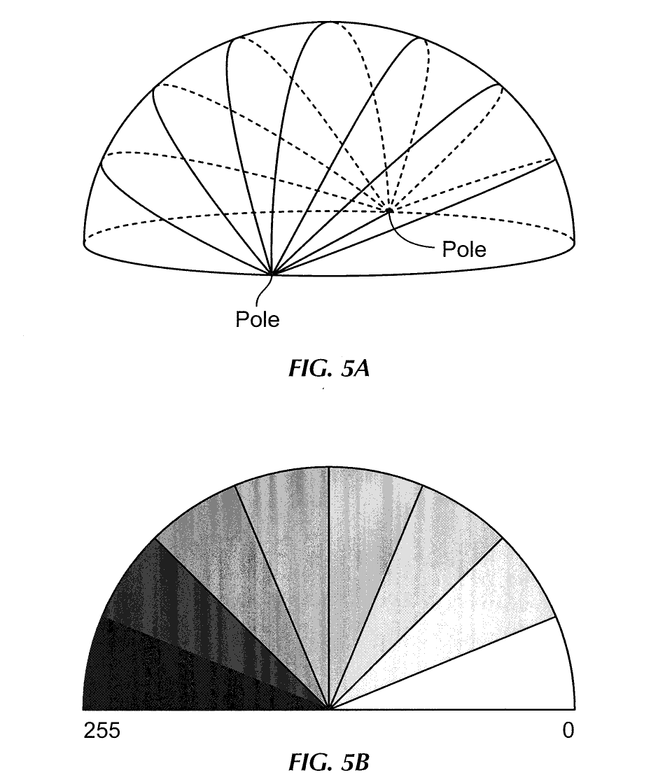

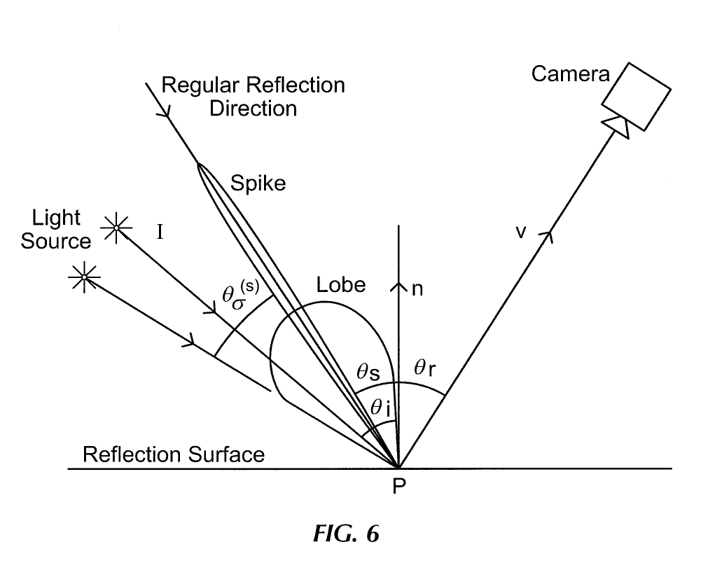

Through the use of the lighting device 3 having such light source distribution, the surface profile (normal) can be measured even with respect to the measuring target 4 in which the reflectance property is not uniform. Specular lobe occurs when the surface of the measuring target 4 is an imperfect mirror surface. Therefore, the reflected light of the light entered to the object surface includes sharp and narrow light (specular spike) in the regular reflection direction and faintly spread light (specular lobe) in the direction shifted from the regular reflection direction, as shown in FIG. 6. Here, the shift (angle) from the regular reflection direction and the ratio of the light intensity of the lobe with respect to the spike represent the reflectance property. The shape of the lobe differs according to the surface roughness on each position in an object in which the reflectance property is not uniform. For very rough surfaces, it just include specular lobe.

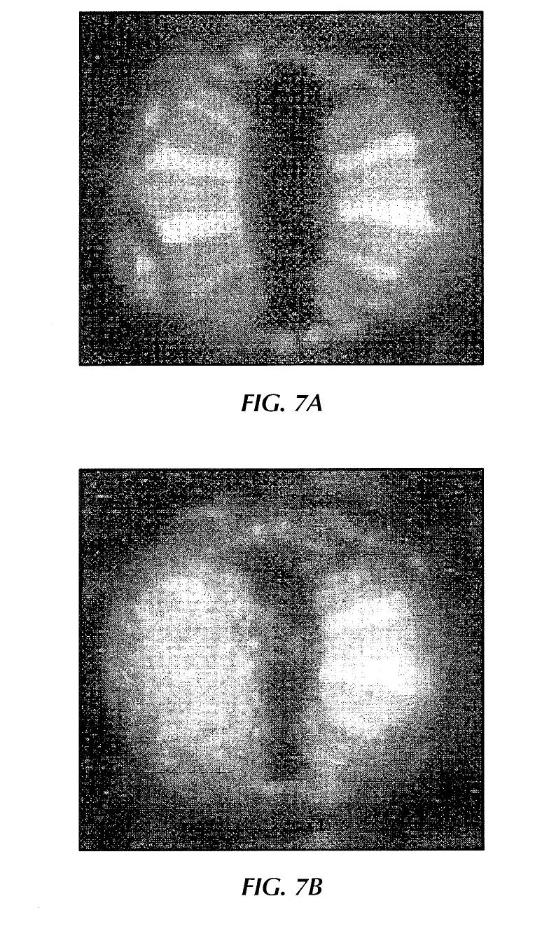

With the presence of spread of the lobe, the luminance value in the photographed image is subjected to influence of not only the light from the light emission region corresponding to the regular reflection direction of the object, but also the light from the periphery thereof. For instance, if a stripe-form lighting is projected as shown in FIG. 7A, the reflected light mixes with the surrounding light as shown on the left side of FIG. 7B in the object with rough surface.

In this case, if the light from the periphery is canceled and color feature (R/(R+G) etc.) similar to the case of perfect mirror surface is maintained, it can be handled similar to as if performing the measurement with the object of perfect mirror surface as the target. The following description describes canceling the influence of light from the periphery by using the lighting pattern in the present embodiment to thereby enable photography of the image having a color feature similar to the case of the perfect mirror surface.

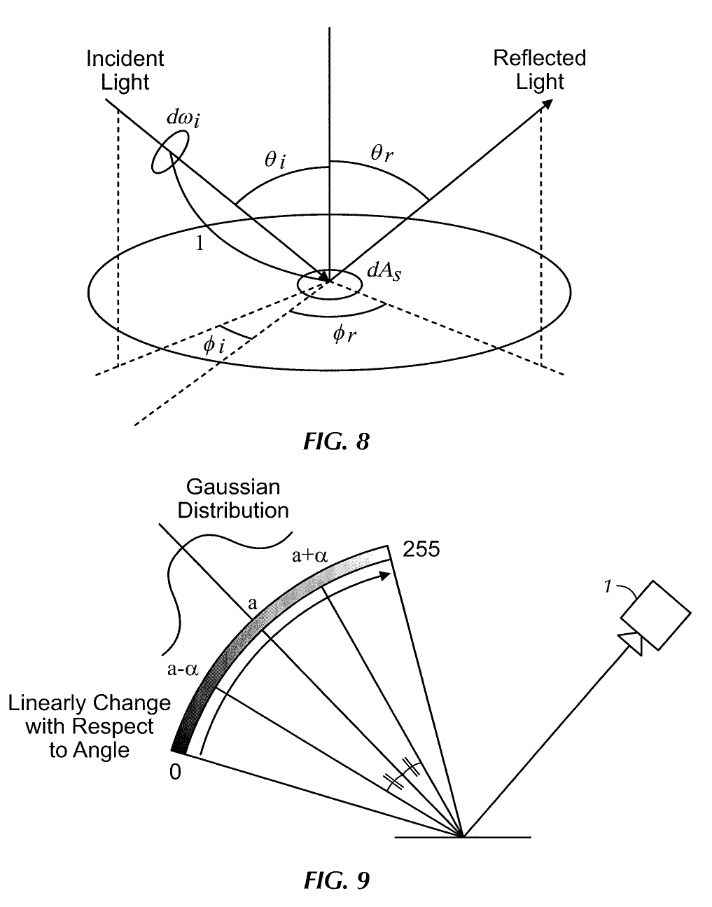

As shown in FIG. 8, consider light incident upon a point p from (θᵢ, φᵢ) direction, and being reflected in (θᵣ, φᵣ) direction. A small solid angle in the (θᵢ, φᵢ) direction at point p is dωᵢ. Assuming a radiance from the small solid angle is Lᵢ(p, θᵢ, φᵢ), this can be considered as the radiance, that is, the light source distribution at (θᵢ, φᵢ) on a sphere of radius one. Viewing a small region dAₛ including point p from the (θᵢ, φᵢ) direction, the corresponding solid angle of this region is dAₛcos θᵢ.

Therefore, the radiation illuminance dEᵢ(p, Ω) to point p by the light entering from the small solid angle dωᵢ can be expressed as below.

$$\begin{matrix}{dE}_{i} ( p , d {ω}_{i} ) = \frac{{L}_{i} ( p , {θ}_{i} , {φ}_{i} ) d {A}_{s} cos {θ}_{i} d ω }{d {A}_{s}} \\ = {L}_{i} ( p , {θ}_{i} , {φ}_{i} ) cos {θ}_{i} d ω\end{matrix}$$

Therefore, the radiance Lᵣ(p, θᵣ, φᵣ) from point p to (θᵣ, φᵣ) can be expressed as below using the reflectance property f of the object surface.

$$\begin{matrix}{L}_{r} ( p , {θ}_{r} , {φ}_{r} ) = {\int }_{Ω} \int f ( p , {θ}_{i} , {φ}_{i} , {θ}_{r} , {φ}_{r} ) d {E}_{i} ( p , d {ω}_{i} ) \\ = {\int }_{Ω} \int f ( p , {θ}_{i} , {φ}_{i} , {θ}_{r} , {φ}_{r} ) {L}_{i} ( p , {θ}_{i} , {φ}_{i} ) cos {θ}_{i} d {ω}_{i} \\ = {\int }_{Ω} \int f ( p , {θ}_{i} , {φ}_{i} , {θ}_{r} , {φ}_{r} ) {L}_{i} ( p , {θ}_{i} , {φ}_{i} ) cos {θ}_{i} sin {θ}_{i} d {θ}_{i} d {φ}_{i}\end{matrix} \qquad ( 1 )$$

Here, Ω of the integral range represents the solid angle on the hemispherical surface, that is, the range of the light source distribution.

If the object surface is a perfect mirror surface, the radiance is expressed as below.

Lᵣ(p,θᵣ,φᵣ)=Lᵢ(p,θᵢₛ,φᵢₛ+π) (2)

Here, (θᵢₛ, φᵢₛ) represents the regular reflection direction from position p in the (θᵣ, φᵣ) direction.

Here, in an arbitrary region (range of light source distribution) Ω(θᵢₛ, φᵢₛ) interiorly including (θᵢₛ, φᵢₛ), the target can be handled as if the target is the mirror surface even if the target surface is not a mirror surface considering the light source distribution Lᵢ(p, θᵢ, φᵢ) satisfying the right side of the equation (1)=the right side of the equation (2). That is, the spectral characteristic in the regular reflection direction is always detectable even if the reflectance property of the measuring target changes. The light source distribution satisfying the right side of the equation (1)=the right side of the equation (2) can be expressed as being the light source distribution in which the radiance of the center of gravity of the light source distribution of a point symmetric region coincides with the radiance of the center of the point symmetric region in an arbitrary point symmetric region on the light emission region.

Since such light source distribution Lᵢ(p, θᵢ, φᵢ) is difficult to derive analytically, it is realistic to use approximation solution. The pattern (FIG. 5A) in which the luminance linearly changes with respect to the longitude direction as described above used in the present embodiment is one of such approximation solution. The lighting pattern (FIG. 4) combining such patterns is also an approximation solution.

The canceling out of the influence of the specular lobe (diffuse reflection) by the lighting pattern in which the luminance linearly changes with respect to the longitude direction as shown in FIG. 5A is referenced from a different standpoint with reference to FIG. 9. FIG. 9 shows a view showing a one-dimensional direction of an equatorial direction in which effects close to an ideal are obtained to describe the effects by such lighting pattern. Here, consider only light from three points of an angle a (regular reflection direction), an angle a+α, and an angle a−α. The lobe coefficient of the light from the positions of the angles a+α, a−α is equal to each other, and is σ. The light emission intensity of the lighting device 3 is proportional to the angle (longitude), and is (a−α)L, aL, (a+α)L at the respective position of the angle of a−α, a, a+α. The synthesis of the reflected light from the three points becomes σ(a−α)L+aL+σ(a+α)L=(1+2σ)aL, and the influence of the diffusion light of the light from the periphery is canceled out. Only two points of a±α are considered here, but it should be easily understood that the influence of the diffusion light of the light from the periphery is completely canceled out. Therefore, the feature quantity represented by the ratio of the light emission intensity of each color of RGB becomes the same value as the case of the perfect mirror surface reflection.

The equatorial direction is the direction most ideal effects are obtained. In other directions, the linearity described above is broken and in a narrow sense, the influence of the diffuse reflection (specular lobe) cannot be canceled out, but the influence of the diffuse reflection can be removed in a range not posing practical problems.

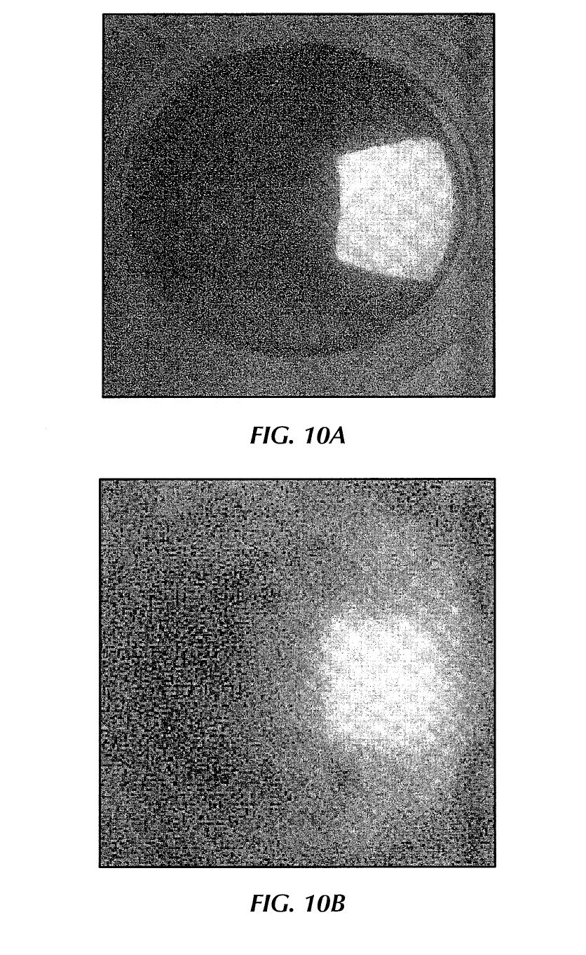

The periphery of the lighting region is blurred between a case in which the mirror surface object is irradiated with the lighting of the present embodiment as shown in FIG. 10A and a case in which the object in which the reflectance property is not uniform is irradiated with the lighting of the present embodiment as shown in FIG. 10B, but the color feature is maintained in the interior. Therefore, even when targeting the object in which the reflectance property is not uniform, the surface profile can be acquired similar to the case of the perfect mirror surface reflection.

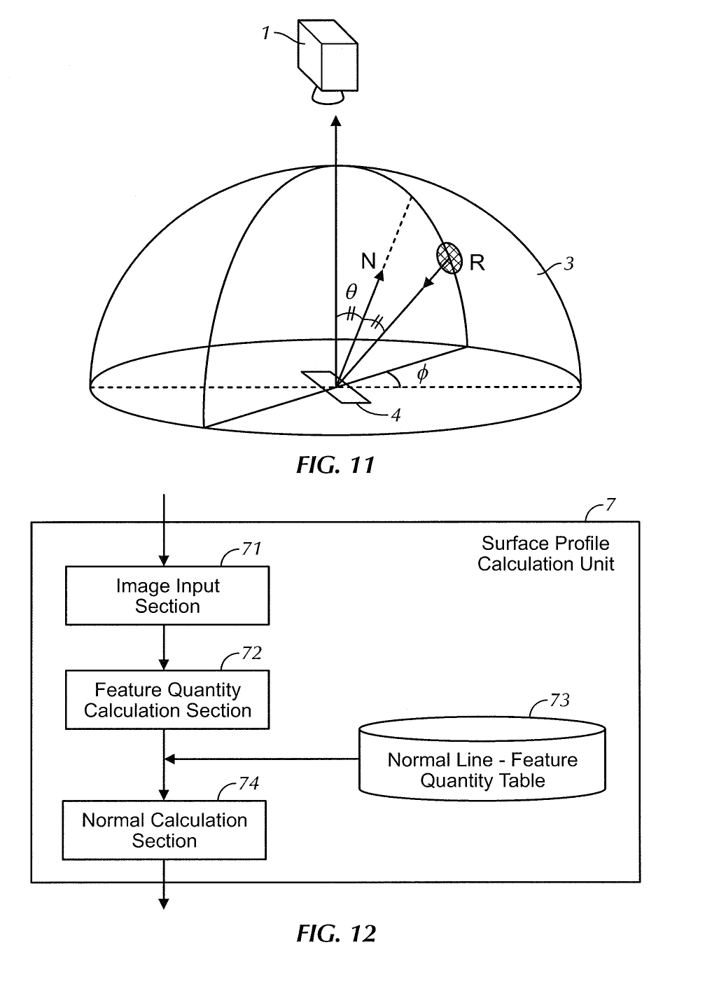

As described above, through the use of the lighting device 3 according to the present embodiment, the target can be handled the same way as the perfect mirror surface object irrespective of the reflectance property of the measuring target. The lighting pattern of the lighting device 3 combines patterns in which RGB gradually changes in different directions, as shown in FIG. 4, and thus light of spectral distribution different at all positions is emitted. Through the use of the lighting device 3 that emits light of spectral distribution different at all positions of the light emission region, the surface profile (normal) of the measuring target 4 can be measured from only one image. This will be described with reference to FIG. 11. Assume the direction of the normal line at a certain position on the surface of the measuring target 4 is the direction of an arrow N, the zenith angle is θ, and the azimuth angle is φ. In this case, since specular reflection preserves the color of the illumination, the color of the position photographed by the camera 1 becomes the reflected light of the light emitted in the region R of the lighting device 3 and entered to the measuring target 4. Thus, the direction (θ, φ) of the normal line of the surface and the direction of the incident light (position in the light emission region of the lighting device 3) have a one to one correspondence. Since the light incident from different directions have different spectral distributions (emitting light of spectral distribution different at all positions in the light emission region), the lighting device 3 can examine the color (spectral distribution) of the photographed image to calculate the direction of the normal line at the relevant position for both the zenith angle and the azimuth angle.

[Normal Calculation Section]

The details of the surface profile calculation process will be described below while describing the surface profile calculation unit 7 in the computer 6. FIG. 12 shows a view showing more detailed function blocks of the surface profile calculation unit 7. As shown in the figure, the surface profile calculation unit 7 includes an image input section 71, a feature quantity calculation section 72, a normal line—feature quantity table 73, and a normal calculation section 74.

The image input section 71 is a function section for accepting the input of images photographed by the cameras 1, 2. When receiving the analog data from the cameras 1, 2, the image input section 71 converts the analog data to digital data. The image input section 71 may receive image of digital data by USB terminal, IEEE 1394 terminal, and the like. In addition, a configuration of reading images from a portable storage medium through a LAN cable may be adopted.

The feature quantity calculation section 72 calculates the feature quantity related to the spectral component of the reflected light for each pixel reflecting the measuring target 4 from the input photographed image. In the present embodiment, the lighting device 3 projects light combining three component lights of red light (R), green light (G), and blue light (B), and thus the ratio of each component of RGB is used for the feature quantity. For instance, for each component of RGB, the combination of (R, G, B) is set as the feature quantity after normalizing the maximum luminance at one. The ratio of another color with respect to a certain color (here, G) such as the combination of the values of R/(R+G), B/(B+G) and G may be set as the feature.

As described above, the color of the measuring target 4, that is, the feature quantity calculated by the feature quantity calculation section 72 correspond to the direction of the normal line at one to one. The normal line—feature quantity table 73 is a storage section for storing such correspondence relationship. The normal line—feature quantity table 73 can be created by performing photography using the lighting device 3 and the cameras 1, 2 on an object which shape such as perfect sphere is known, and examining the correspondence relationship between the normal line and the feature quantity in advance. For instance, when using an object of a perfect sphere, the direction of the normal line can be obtained through calculation by examining the position from the center of the focusing pixel. The correspondence relationship between the direction of the normal line and the feature quantity can be examined by calculating the feature quantity at the relevant position.

The normal calculation section 74 calculates the direction of the normal line at each position of the measuring target from the feature quantity calculated from the input image, and the normal line—feature quantity table 73.

### Effects of Embodiment

1. Surface Profile of an Object in Which the Reflectance Property or Surface Roughness is Not Uniform is Measurable

As described above, the profilometer according to the present embodiment can photograph an image having spectral characteristics similar to a perfect mirror surface even on a target in which the reflectance property is not uniform. Therefore, even with respect to a target in which the reflectance property is not uniform, or even with respect to a target in which the reflectance property is uniform but is different from the reflectance property of the reference object, the surface profile (direction of normal line) thereof can be calculated with satisfactory accuracy.

The following additional effects can be obtained by using the lighting device 3 of the present embodiment.

2. Normal Line Can be Calculated Only From One Image

The profilometer according to the present embodiment uses the lighting device such that light of different spectral distribution enters for all incident angle directions, and thus the direction of the normal line of the object to be measured can be obtained only from one image with respect to both the zenith angle component and the azimuth angle component. Since the photographing of the image is performed only once, and the calculation of the direction of the normal line is carried out by simply examining the table storing the correspondence relationship of the normal line and the feature quantity, the surface profile of the measuring target can be easily (at high speed) measured.

3. Natural Observation is Possible on Diffuse Object (Lambertian Surface)

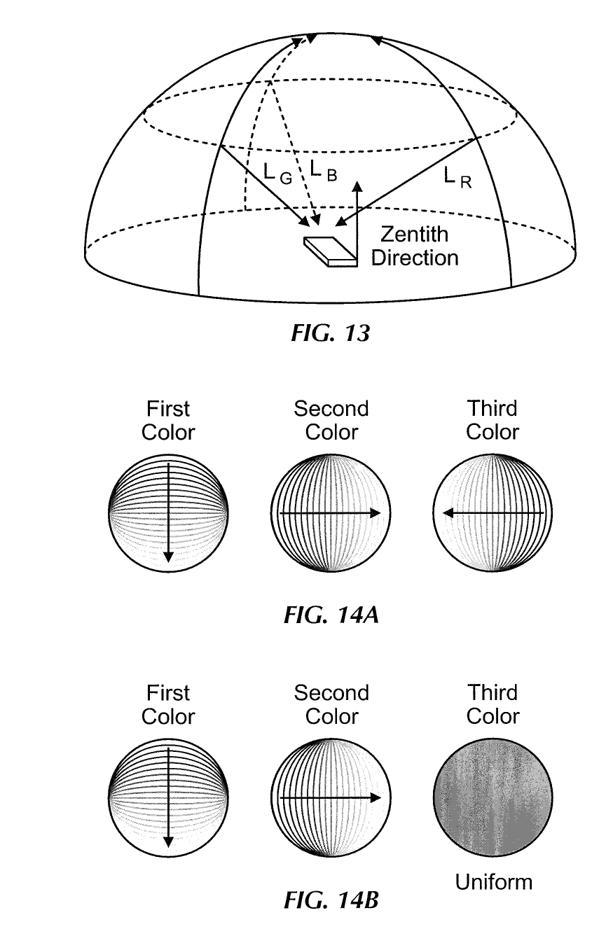

When photographing a diffuse object (Lambertian surface), the image is a mixture of incident light from various directions. In the present embodiment, the light emission region of the lighting device 3 has the light of three components of RGB changed in equal directions (direction of 120 degrees with respect to each other) as shown in FIG. 4 and the degree of change is set the same. Therefore, as shown in FIG. 13, with respect to an arbitrary zenith angle, the sum of the light intensity per one color from all azimuth angle directions at the relevant zenith angle is the same in each color. The sum of the light intensity of each color is the same even if integration is performed for all zenith angles. Thus, the component light of RGB of the light entering the camera 1 positioned in the vertical direction from the diffuse object all have the same intensity, and the photographed image thereof has white reflected light photographed with respect to the diffuse object. That is, when the photographing object is configured from both the mirror surface object (object to be measured) and the diffuse object, the surface profile of the mirror surface object can be measured, and photography under white light illumination becomes possible for the diffuse object. For instance, when carrying out a joining test of a solder, each target other than the solder could be inspected using color information of target itself.

4. Alleviation of Luminance Dynamic Range Problem

Through the use of the lighting device of the present embodiment, even if an object including both specular spike and specular lobe, the luminance of the mirror reflection light and the specular lobe becomes small compared to a case where observing them under a point light source. Therefore, the dynamic range of the image sensor (camera) does not need to be widened.

<Variant>

In the description of the embodiment above, the lighting device in which patterns that change with angle with respect to a direction in which the light emission intensity of three colors of RGB differs by 120 degrees are overlapped is used, but the light emission pattern is not limited thereto. For instance, a combination of patterns in which the three colors respectively change with respect to different directions such as patterns in which three colors change to downward direction, rightward direction, and leftward direction as shown in FIG. 14A may be used. All three colors do not need to be changed with angle, and a pattern that emits light at uniform luminance at the entire surface for one color, and patterns that change with angle in different directions for the other two colors as shown in FIG. 14B may be adopted.

The light emission of the lighting device 3 of the present embodiment is configured to also exhibit the above-described additional effects. If only the effect that the object in which the reflectance property is not uniform can be photographed same as the perfect mirror surface is to be obtained, the lighting patterns of three colors of RGB do not need to be overlapped. For instance, the lighting of RGB that respectively linearly changes with angle may be sequentially activated to photograph three images, and the three images may be analyzed to calculate the surface profile of the measuring target.

In the above description, the image is photographed in advance using an object which shape is known, the relationship between the feature quantity of the spectral distribution and the direction of the normal line is obtained based on the image, and the normal line—feature quantity table is created. The direction of the normal line is obtained from the feature quantity of the spectral distribution of the measuring target with reference to the normal line —feature quantity table. However, if the relationship of the direction of the normal line and the spectral distribution photographed by the camera can be formulated from the geometric arrangement and the like, the normal line may be calculated using such calculation formula.

### Second Embodiment

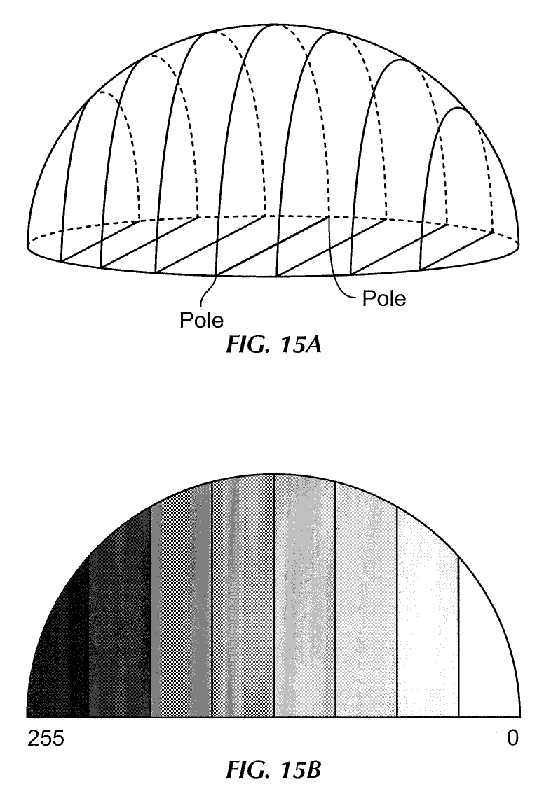

In the first embodiment, a pattern in which the light emission intensity linearly changes with respect to the angle in the longitude direction as shown in FIG. 5A is used as an approximation solution of a lighting pattern with which the spectral characteristics in the regular reflection direction can always be detected in the photographed image even if the reflectance property changes. In the present embodiment, a pattern in which the light emission intensity linearly changes with respect to a latitude direction as shown in FIG. 15 is adopted. Such lighting pattern is also one approximation solution, and the influence of diffusion light can be substantially canceled out to enable the detection of the regular reflection light.

### Third Embodiment

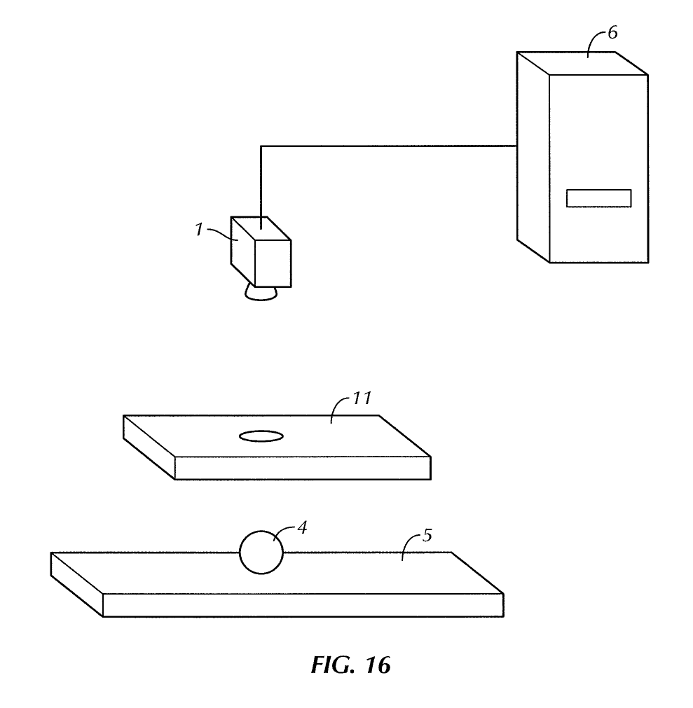

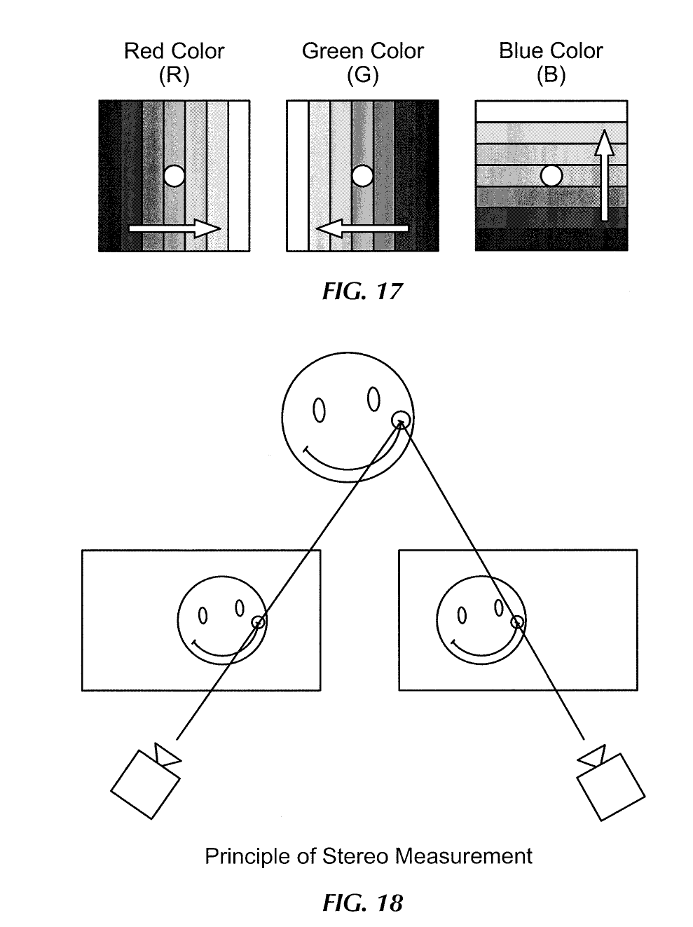

In a profilometer according to the third embodiment, a lighting device having a shape different from the first and the second embodiments is used. As shown in FIG. 16, a flat plate-shaped lighting device 11 is used in the present embodiment. In the present embodiment as well, the spectral distribution of the light emission at each position in the light emission region is differed at all positions. Specifically, similar to the first embodiment, when determining light emission by synthesis of light components of three colors of red light (R), green light (G), and blue light (B), each color is changed with respect to different directions as shown in FIG. 17. Here, the light emission intensity of R becomes larger towards the rightward direction, the light emission intensity of G becomes larger towards the leftward direction, and the light emission intensity of B becomes larger towards upward direction. The proportion of change in the light emission intensity is linear with respect to angle whose origin is the intersecting point of optical axis of the camera 1 and the plane 5 in FIG. 16.

The lighting pattern in which the light emission intensity linearly changes with respect to position on a plane is one approximation solution of a lighting pattern that cancels out the influence of diffusion light. Therefore, through the use of such lighting pattern, the calculation of the surface profile can be performed similar to the perfect mirror surface regardless of the reflectance property of the measuring target.

The light combining each component light of RGB has different spectral distribution at all positions. Therefore, in the present embodiment as well, the surface profile of the measuring target can be obtained only from one photographed image, similar to the first embodiment.

1. A profilometer for measuring a surface profile of a measuring target, the measurement device comprising:
a lighting device for irradiating the measuring target with light;
an imaging device for imaging a reflected light from the measuring target; and
a normal calculation section for calculating a normal direction of a surface at each position of the measuring target from an imaged image;
wherein the lighting device has a light emission region of a predetermined extent, and
wherein a radiance of center of gravity of a light source distribution of a point symmetric region coincides with a radiance of the center of the point symmetric region in an arbitrary point symmetric region of the light emission region.

2. The profilometer according to claim 1, wherein in the lighting device, when a light source distribution entering a measurement point p from a direction of an incident angle (θᵢ, φᵢ) is Lᵢ(p, θᵢ, φᵢ), the radiance of the imaged image is equal to Li(p, θᵢₛ, φᵢₛ±π), and following conditions are satisfied for an arbitrary normal vector on the p and an arbitrary region Ω:
∫∫_{Ω}Lᵢ(p,θᵢ,φᵢ)·f(p,θᵢ,φᵢ,θᵣ,φᵣ)cos θᵢ sin θᵢdθᵢdφᵢLᵢ(p,θᵢₛ,φᵢₛ±π)
Where:
p: measurement point
θᵢ: incident angle (zenith angle component)
φᵢ: incident angle (azimuth angle component)
θᵣ: reflection angle (zenith angle component)
φᵣ: reflection angle (azimuth angle component)
θᵢₛ: regular reflection incident angle with respect to θᵣ (zenith angle component)
φᵢₛ: regular reflection incident angle with respect to θᵣ (azimuth angle component)
f: reflectance property
Ω: point symmetric region having (θᵢₛ, φᵢₛ) as center.

3. The profilometer according to claim 2, wherein a light source distribution in which the light source distribution Lᵢ(p, θ,φ) is approximated so as not to depend on a position p and a normal vector on the p and so as to be constant with respect to the p and the normal vector on the p is used.

4. The profilometer according to claim 3, wherein considering a sphere having a center as the measuring target and having both poles thereof in a plane including the measuring target,
the light source distribution linearly changes with respect to a longitude of the sphere.

5. The profilometer according to claim 3, wherein considering a sphere having a center as the measuring target and having both poles thereof in a plane including the measuring target,
the light source distribution linearly changes with respect to a latitude of the sphere.

6. The profilometer according to claim 3, wherein the light emission region has a planar shape.

7. The profilometer according to claim 1, wherein the light source distribution of the lighting includes a plurality of light source distributions superimposed on each other, each of the plurality of light source distributions being the light source distribution according to claim 1 and differing from each other in spatial distribution.

8. The profilometer according to claim 2, wherein the light source distribution of the lighting includes a plurality of light source distributions superimposed on each other, each of the plurality of light source distributions being the light source distribution according to claim 2 and differing from each other in spatial distribution.

9. The profilometer according to claim 3, wherein the light source distribution of the lighting includes a plurality of light source distributions superimposed on each other, each of the plurality of light source distributions being the light source distribution according to claim 3 and differing from each other in spatial distribution.

10. The profilometer according to claim 4, wherein the light source distribution of the lighting includes a plurality of light source distributions superimposed on each other, each of the plurality of light source distributions being the light source distribution according to claim 4 and differing from each other in spatial distribution.

11. The profilometer according to claim 5, wherein the light source distribution of the lighting includes a plurality of light source distributions superimposed on each other, each of the plurality of light source distributions being the light source distribution according to claim 5 and differing from each other in spatial distribution.

12. The profilometer according to claim 6, wherein the light source distribution of the lighting includes a plurality of light source distributions superimposed on each other, each of the plurality of light source distributions being the light source distribution according to claim 6 and differing from each other in spatial distribution.
